(19) United States
(12) Patent Application Publication
(10) Pub. No.: US 2025/0272112 A1
(43) Pub. Date: Aug. 28, 2025

(54) SWITCHOVER CONTROL SYSTEM, SWITCHOVER CONTROL METHOD, AND NON-TRANSITORY COMPUTER-READABLE STORAGE MEDIUM

(71) Applicant: RAKUTEN GROUP, INC., Tokyo (JP)

(72) Inventors: Kentaro SASAKI, Tokyo (JP); Tatsuyoshi OKAMOTO, Tokyo (JP)

(21) Appl. No.: 19/057,854

(22) Filed: Feb. 19, 2025

(30) Foreign Application Priority Data
Feb. 22, 2024 (JP) 2024-025622

(51) Int. Cl. G06F 9/445

(52) U.S. Cl. CPC G06F 9/44505

(57) ABSTRACT

A switchover control system includes at least one processor which receives an execution request for the switchover transmitted from the administrator terminal, execute database setting processing, execute virtual server activation processing, execute application activation processing, and execute communication target switching processing. Switchover processing including the database setting processing, the virtual server activation processing, the application activation processing, and the communication target switching processing is executed in response to reception of the execution request, by executing the included processing in the stated order.

### CROSS-REFERENCE TO RELATED APPLICATION

The present application claims priority from Japanese application JP2024-025622 filed on Feb. 22, 2024, the content of which is hereby incorporated by reference into this application.

### BACKGROUND OF THE INVENTION

### 1. Field of the Invention

The present invention relates to a switchover control system, a switchover control method, and a program.

### 2. Description of the Related Art

Switchover is known as a technology for use in a system that employs a redundancy configuration including a running system and a standby system to switch from the active system to the standby system in a case of abnormality caused in the active system by occurrence of a disaster or the like. In switchover, unlike failover in which the switch from the active system to the standby system is automatically executed by a computer upon detection of abnormality of the active system, the switch from the active system to the standby system is manually executed. Owing to this feature, switchover has a merit in that a switch between systems can be executed flexibly by taking various circumstances (a fluctuation in traffic volume due to a switch between systems, a possibility of erroneous detection of abnormality, and the like) in a case of occurrence of an abnormal situation into consideration.

### SUMMARY OF THE INVENTION

For a staff member who does not have specialized knowledge about IT infrastructure such as a server, a database, and a cloud (referred to as “non-specialist staff member” in some places of the following description), it is not easy to execute switchover. Switchover is usually executed by a staff member located at a site other than an active site at which the active system is deployed. However, a staff member who has specialized knowledge about IT infrastructure (referred to as “specialist staff member” in some places of the following description) is often posted at the active site for convenience of system maintenance in normal times and the like, and there may be a shortage of specialist staff or no specialist staff at a site other than the active site. In that case, there may arise a situation in which a non-specialist staff member is required to execute switchover, but it is not easy for a non-specialist staff member to execute switchover in which setting of a database, activation of a server, switching of networks, and the like are required to be executed manually.

At least one aspect of the present invention has been made in view of the problem described above, and one of objects thereof is to provide a switchover control system, a switchover control method, and a program which enable even a staff member who does not have specialized knowledge about IT infrastructure to easily execute switchover.

According to at least one embodiment of the present invention, there is provided a switchover control system for controlling switchover from an active system to a first standby system in a cloud system in which a network interconnects the active system, the first standby system and an administrator terminal. The active system is deployed at an active site, and includes: an already activated active virtual server on which one or more active applications operate; and an active database configured to read and write data based on instructions from the one or more active applications. The first standby system is deployed at a first standby site different from the active site, and includes: an unactivated first standby virtual server in which one or more first standby applications are deployed, the one or more first standby applications being copies of the one or more active applications; and a first standby database which synchronizes data with the active database. The administrator terminal is deployed at a management site different from the active site. The switchover control system is deployed at one or more sites different from the active site. The switchover control system comprises at least one processor configured to: receive an execution request for the switchover transmitted from the administrator terminal; execute database setting processing for setting the first standby database so that data synchronization between the active database and the first standby database is stopped, and so that writing data based on the instructions from the one or more first standby applications is enabled, and for setting the active database so that writing data based on the instructions from the one or more active applications is disabled; execute virtual server activation processing for activating the first standby virtual server; execute application activation processing for activating the one or more first standby applications on the first standby virtual server; and execute communication target switching processing for switching a target of communication to and from one or more client terminals from the active system to the first standby system. The database setting processing, the virtual server activation processing, the application activation processing, and the communication target switching processing are included in switchover processing, and are executed in the stated order in response to reception of the execution request.

According to the at least one aspect of the present invention, even the staff member who does not have specialized knowledge about IT infrastructure can easily execute switchover.

### BRIEF DESCRIPTION OF THE DRAWINGS

FIG. 1A is a diagram for illustrating an outline of a switchover control system according to at least one embodiment of the present invention.

FIG. 1B is a diagram for illustrating the outline of the switchover control system according to the at least one embodiment of the present invention.

FIG. 1C is a diagram for illustrating the outline of the switchover control system according to the at least one embodiment of the present invention.

FIG. 1D is a diagram for illustrating the outline of the switchover control system according to the at least one embodiment of the present invention.

FIG. 1E is a diagram for illustrating the outline of the switchover control system according to the at least one embodiment of the present invention.

FIG. 1F is a diagram for illustrating the outline of the switchover control system according to the at least one embodiment of the present invention.

FIG. 2 is a diagram for illustrating a hardware configuration of a cloud system according to the at least one embodiment of the present invention.

FIG. 3 is a block diagram for illustrating function configurations of an active system, a first standby system, and a second standby system.

FIG. 4 is a block diagram for illustrating a function configuration of the switchover control system according to the at least one embodiment of the present invention.

FIG. 5 is a table for showing an example of access information.

FIG. 6A is a flow chart for illustrating an example of processing executed in the switchover control system according to the at least one embodiment of the present invention.

FIG. 6B is a flow chart for illustrating the example of the switchover control system the processing executed in according to the at least one embodiment of the present invention.

FIG. 6C is a flow chart for illustrating the example of the processing executed in the switchover control system according to the at least embodiment of the present invention.

### DETAILED DESCRIPTION OF THE INVENTION

Now, at least one embodiment of the present invention is described with reference to the drawings.

### [1. Outline of Switchover Control System]

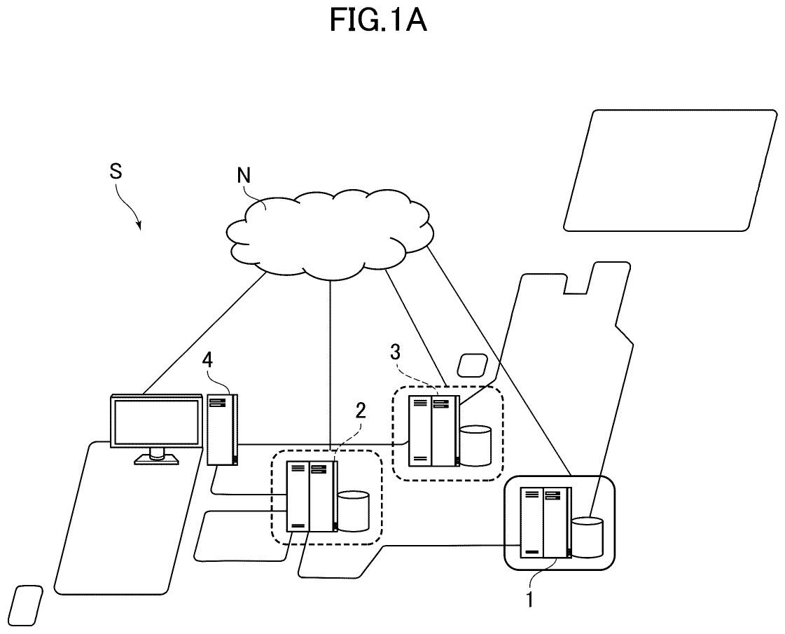

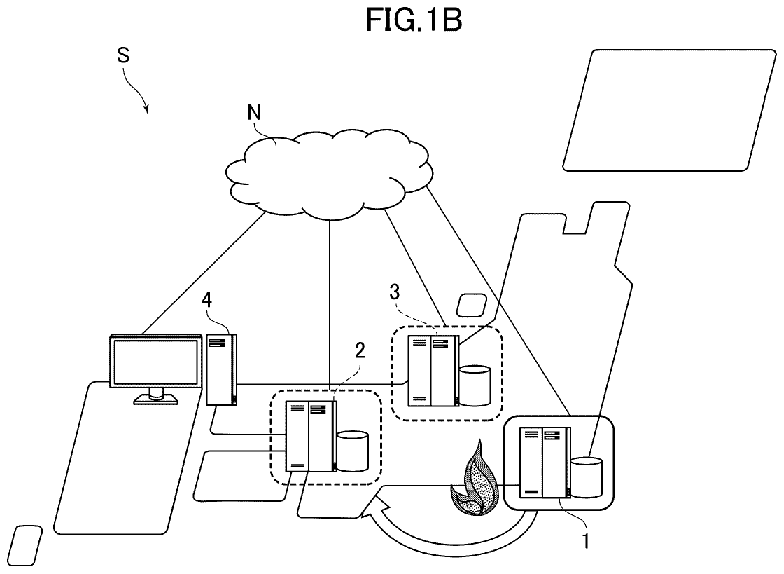

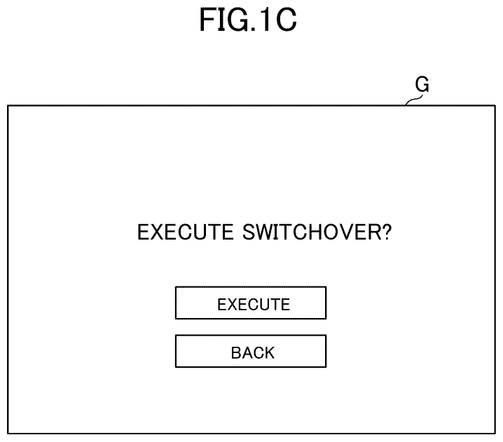

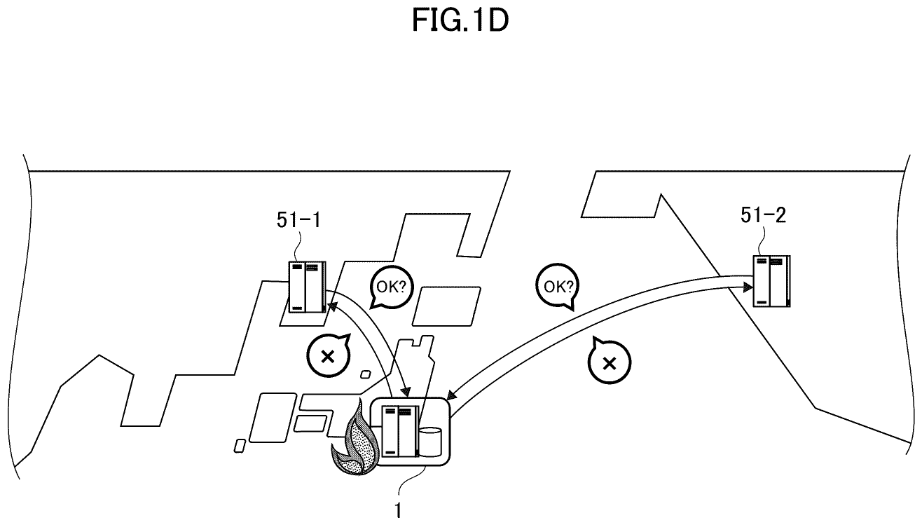

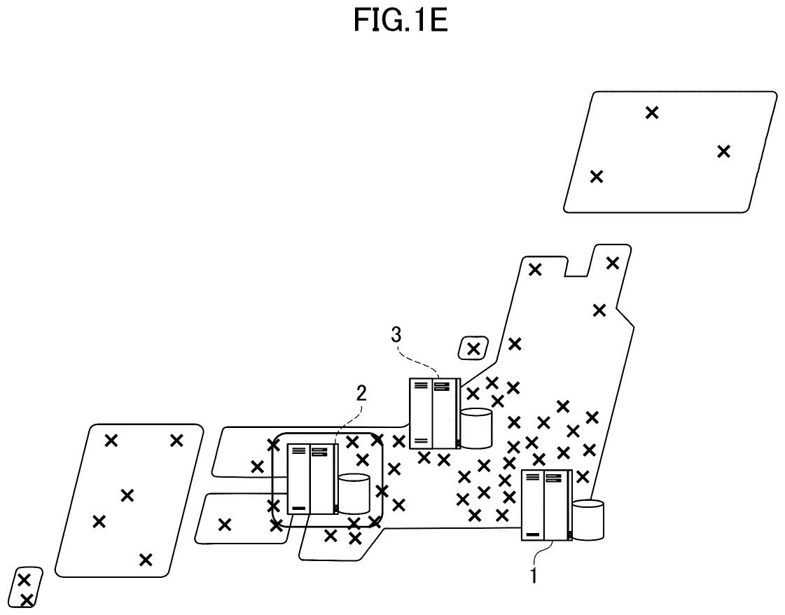

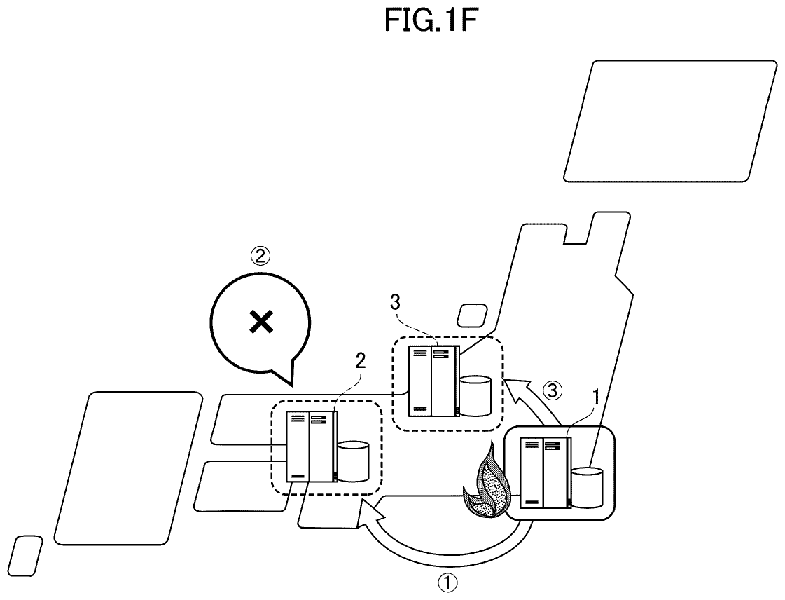

FIG. 1A to FIG. 1F are diagrams for illustrating an outline of a switchover control system according to the at least one embodiment of the present invention.

Some of systems that: provide Web services such as electronic commerce transactions and financial transactions employ a redundancy configuration in order to continue providing the service despite occurrence of a disaster, a cyberattack, an act of terrorism, or other abnormal situations.

As an example of such system that employs a redundancy configuration, a cloud system S is illustrated in FIG. 1A. The cloud system S is a cloud system provided by a public cloud service, for example, Amazon Web Services (AWS) (trademark),

Microsoft Azure (trademark), or Google Cloud Platform (trademark). The cloud system S may be an on-premises cloud system run by an enterprise that provides the service itself.

As illustrated in FIG. 1A, the cloud system S includes, as main components, an active system 1, a first standby system 2, a second standby system 3, and an administrator terminal 4. In a general description given below, the active system 1 may simply be referred to as “active system,” and the first standby system 2 and the second standby system 3 may collectively and simply be referred to as “standby systems.”

The active system 1 is a system that provides a service in normal times. In the active system 1, a virtual server is already activated, and the service is provided by a function of an application operating on the virtual server. In the active system 1, data can be read from and written to a database based on an instruction from the application. The active system 1 in the example illustrated in FIG. 1A is deployed in Tokyo, which is an active site.

The first standby system 2 and the second standby system 3 are systems that are in a standby state in normal times. A virtual server of each of the first standby system 2 and the second standby system 3 has not been activated, and a copy of the application related to the service is deployed. Data in a database of each of the first standby system 2 and the second standby system 3 is synchronized with data in the database of the active system 1. In the example illustrated in FIG. 1A, the first standby system 2 is deployed in Osaka, which is a first standby site, and the second standby system 3 is deployed in Nagaoka, which is a second standby site.

The administrator terminal 4 is a terminal of a staff member who is an administrator tasked to execute switchover described later in the event of an abnormality situation occurring in the active system 1. The administrator terminal 4 is deployed in Fukuoka, which is a management site.

In a case in which abnormality occurs in the active system in the system employing a redundancy configuration as illustrated in FIG. 1B, the provider of the service is required to be switched from the active system to one of the standby systems. In the following description, the switch of the provider of the service from the active system to one of the standby systems may simply be referred to as “switch between systems” or the like.

As technologies for such switch between systems, failover and switchover are known. In failover, the switch from the active system to the standby system is automatically executed by a computer upon detection of abnormality of the active system. In contrast, in switchover, the switch from the active system to the standby system is manually executed. Switchover has a merit in that a switch between systems can be executed flexibly by taking various circumstances (a fluctuation in traffic volume due to a switch between systems, a possibility of erroneous detection of abnormality, and the like) in a case of occurrence of an abnormal situation into consideration.

However, for a non-specialist staff member, it is not easy to execute switchover. As described above, switchover is usually executed by a staff member located at a site (Fukuoka) other than Tokyo, at which the active system is deployed. However, a specialist staff member is often posted at Tokyo for convenience of system maintenance in normal times and the like, and there may be a shortage of specialist staff or no specialist staff at a site other than Tokyo. Then, a situation may arise in which, in order to continue the service after an emergency situation such as a natural disaster occurs in Tokyo, a non-specialist staff member is required to execute switchover in place of specialist staff located in Tokyo. However, it is not easy for a non-specialist staff member to execute switchover in which setting of the database, activation of the virtual server, switching of networks, and the like are required to be executed manually.

In view of the problem described above, the inventors of the present invention have thought of a switchover control system 5 according to the at least one embodiment. In the switchover control system 5, switchover processing including database setting processing, virtual server activation processing, application activation processing, and communication target switching processing is executed. Outline of each piece of processing is described below.

### [Database Setting Processing]

In normal times, data can be read out of the database of each standby system, but cannot be written to the database of the standby system. Accordingly, in executing switchover, settings that enable writing data to the database of the standby system are required to be set. It is also required to set, in order to maintain consistency of the database after switchover, settings that stop synchronization between the database of the active system which has originally been in operation and the database of each standby system, and that disable writing data to the database of the active system.

To fulfill the requirements, in the switchover control system 5 according to the at least one embodiment, settings that (1) stop synchronization between the database of the active system and the database of each standby system, (2) enable writing data to the database of the standby system, and (3) disable writing data to the database of the active system are set as the database setting processing.

### [Virtual Server Activation Processing and Application Activation Processing]

In a public cloud service such as AWS, even when an application is not actually operating on the virtual server of the standby system, that is, even when the standby system is not providing the service, a fee for the use of the virtual server is charged as long as the virtual server is activated. Accordingly, in normal times, the virtual server of each standby system is only deployed in the standby system and is not activated.

To address this, in the switchover control system 5 according to the at least one embodiment, virtual server activation processing for activating the virtual server of the standby system is executed. In the switchover control system 5, application activation processing for activating the application on the activated virtual server of the standby system is executed as well.

### [Communication Target Switching Processing]

In normal times, the active system holds communication to and from a client terminal (reception of a request from the client terminal, transmission of data to the client terminal, and the like), and is accordingly set as a communication target of communication to and from the client terminal.

To address this, in the switchover control system 5 according to the at least one embodiment, the communication target of communication to and from the client terminal is switched from the active system to the first standby system as the communication target switching processing.

In the at least one embodiment, the switchover processing described above is executed just by transmitting a switchover execution request from the administrator terminal 4 to the switchover control system 5 (more specifically, a switchover execution system 50). An example of a screen G displayed on the administrator terminal 4 when transmitting the switchover execution request to the switchover control system 5 is illustrated in FIG. 1C. Even a non-specialist staff member can execute switchover just by selecting an “execute” button on the screen G.

The switchover control system 5 according to the at least one embodiment thus enables even a staff member who does not have specialized knowledge about IT infrastructure to execute switchover with ease.

In the switchover control system 5, the database setting, the virtual server activation, the application activation, and the communication target switching are automatically executed in order, but timing of starting switchover itself is determined by a staff member who executes switchover himself or herself.

Accordingly, the merit of switchover in that a switch between systems can be executed flexibly can still be enjoyed in the switchover control system 5.

The switchover control system 5 according to the at least one embodiment also has a function for preventing erroneous detection of abnormality in the active system 1, a function for selecting an optimum switchover destination, and a function for changing the switchover destination depending on a state of the switchover destination.

### [Prevention of Switchover Based on Erroneous Detection of Abnormality in the Active System 1]

In a system that executes switchover based on a monitoring result from one site, switchover is executed not only when abnormality occurs in the active system 1 but also when there is a problem in communication between the one site and the active system 1 although the active system 1 is operating normally, and the latter is erroneous execution.

The switchover control system 5 according to the at least one embodiment addresses this by monitoring the active system 1 for whether the active system 1 is operating normally with use of monitoring apparatus 51-1 and 51-2 each of which is deployed in one of a plurality of sites as illustrated in FIG. 1D. In the switchover control system 5, whether the active system 1 is operating normally is determined based on respective results of monitoring the active system 1 from the plurality of sites and, when it is determined that the active system 1 is operating normally, switchover is not executed.

According to this configuration in which whether the active system 1 is operating normally is determined based on monitoring results from a plurality of sites, erroneous detection of abnormality due to a problem of communication between a specific site and the active system 1 can be suppressed.

### [Selection of Optimum Switchover Destination]

One of objects of switchover (and redundancy) is to continue provision of the service despite abnormality occurring in the active system. In a case in which selection of the switchover destination is not appropriate, quality of the service may drop after switchover. For example, in a case in which the switchover destination is in a place distant from a region that is high in the number of accesses to the original active system, latency increases after switchover and consequently invites a drop in the quality of the service.

To address this, as illustrated in FIG. 1E, the switchover control system 5 according to the at least one embodiment selects, as the switchover destination, a system deployed at a site included in a region that is higher in the number of accesses to the active system 1, based on access information which indicates, for each of a plurality of regions, the number of accesses to the active system 1 from the region.

According to this configuration in which the switchover destination is the system deployed at a site included in a region higher in the number of accesses to the original active system 1, an increase in latency after switchover and a resultant drop in the quality of the service can be suppressed.

### [Changing Switchover Destination Depending on State of Switchover Destination]

A public cloud system such as AWS (trademark) generally employs a so-called multi-tenant architecture in which respective systems of a plurality of business operators called tenants are deployed in data centers of respective sites. In a cloud system of this type, when a disaster occurs in Tokyo, for example, tenant-related systems that are deployed in a data center of Tokyo are expected to be switched by failover or switchover to standby systems deployed in data centers of other sites such as Osaka. In a case in which switching destinations of the systems are centered on one data center, processing power of the systems deployed in the one data center may decrease due to tightness of hardware resources of the one data center and congestion of a network. When switchover to a system thus decreased in processing power is executed, it becomes difficult after switchover to properly deal with a request transmitted from a client terminal, and the difficulty invites a drop in the quality of the service.

To address this, as illustrated in FIG. 1F, the switchover control system 5 according to the at least one embodiment determines, before starting the switchover processing and in the middle of the switchover processing, whether a system selected as the switchover destination can operate normally and, when it is determined that the system cannot operate normally, re-executes the switchover processing from the start with a new switchover destination.

According to this configuration in which the switchover destination is changed when it is determined that a system selected as the switchover destination cannot operate normally, switchover to a standby system decreased in processing power is prevented, and a drop in the quality of the service can accordingly be suppressed.

In the following, description is given on details of the switchover control system 5 according to the at least one embodiment described above.

### [2. Hardware Configuration]

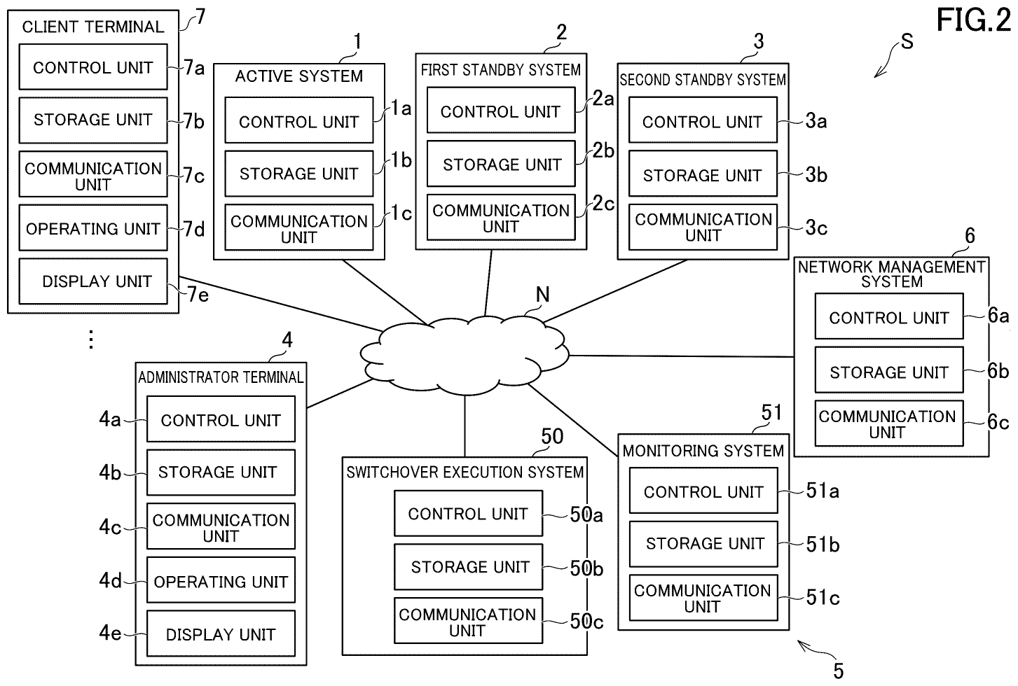

FIG. 2 is a diagram for illustrating a hardware configuration of the cloud system S according to the at least one embodiment of the present invention. The cloud system S includes the active system 1, the first standby system 2, the second standby system 3, the administrator terminal 4, the switchover control system 5, a network management system 6, and a plurality of client terminals 7. The active system 1, the first standby system 2, the second standby system 3, the administrator terminal 4, the switchover control system 5, the network management system 6, and the plurality of client terminals 7 are connected to one another by a network N. The network N includes networks such as the Internet, a WAN, and a LAN.

### [2-1. Active System]

The active system 1 is a computer system configured from one or more computers that are installed in a data center located in Tokyo. The term “data center” refers to a facility in which a computer, a communication apparatus, and the like are a installed. The active system 1 includes a control unit 1a, a storage unit 1b, and a communication unit 1c.

The control unit 1a is a program control device such as a CPU that operates in accordance with a program stored in, for example, the storage unit 1b. The storage unit 1b includes, for example, a storage device such as a ROM and a RAM, and a hard disk drive. The storage unit 1b stores, among others, a program executed by the control unit 1a. The communication unit 1c is a communication interface such as a network board or a wireless LAN module.

### [2-2. First Standby System]

The first standby system 2 is a computer system configured from one or more computers that are installed in a data center located in Osaka. The first standby system 2 includes a control unit 2a, a storage unit 2b, and a communication unit 2c. The control unit 2a, the storage unit 2b, and the communication unit 2c may have the same physical configurations as the physical configurations of the control unit 1a, the storage unit 1b, and the communication unit 1c, respectively.

### [2-3. Second Standby System]

The second standby system 3 is a computer system configured from one or more computers that are installed in a data center located in Nagaoka. The second standby system 3 includes a control unit 3a, a storage unit 3b, and a communication unit 3c. The control unit 3a, the storage unit 3b, and the communication unit 3c may have the same physical configurations as the physical configurations of the control unit 1a, the storage unit 1b, and the communication unit 1c, respectively.

### [2-4. Administrator Terminal]

The administrator terminal 4 is a computer of a staff member who is an administrator tasked to execute switchover.

The administrator terminal 4 is a personal computer, a tablet terminal, a smartphone, a wearable terminal, or the like. In the at least one embodiment, the administrator terminal 4 is installed in Fukuoka.

The administrator terminal 4 includes a control unit 4a, a storage unit 4b, a communication unit 4c, an operating unit 4d, and a display unit 4e. The control unit 4a, the storage unit 4b, and the communication unit 4c may have the same physical configurations as the physical configurations of the control unit 1a, the storage unit 1b, and the communication unit 1c, respectively. The operating unit 4d is an input device such as a keyboard, a mouse, and a touch panel. The display unit 4e is a display such as a liquid crystal display or an organic EL display.

### [2-5. Switchover Control System]

The switchover control system 5 is a computer system configured from a plurality of computers. The switchover control system 5 includes the switchover execution system 50 and a monitoring system 51.

### [2-5-1. Switchover Execution System]

The switchover execution system 50 is a computer system configured from one or more computers. In the at least one embodiment, the one or more computers from which the switchover execution system 50 is configured are installed in Osaka.

The switchover execution system 50 includes a control unit 50a, a storage unit 50b, and a communication unit 50c. The control unit 50a, the storage unit 50b, and the communication unit 50c may have the same physical configurations as the physical configurations of the control unit 1a, the storage unit 1b, and the communication unit 1c, respectively.

### [2-5-2. Monitoring System]

The monitoring system 51 is a computer system configured from a plurality of computers (monitoring apparatus). Each monitoring apparatus is configured from one or more computers. In the at least one embodiment, as illustrated in FIG. 1D, the monitoring system 51 includes the monitoring apparatus 51-1 installed in South Korea and the monitoring apparatus 51-2 installed in the United States of America. The monitoring system 51 may include three or more monitoring apparatus. Locations at which the monitoring apparatus are installed are not limited to the example given above.

The monitoring system 51 includes a control unit 51a, a storage unit 51b, and a communication unit 51c. The control unit 51a, the storage unit 51b, and the communication unit 51c may have the same physical configurations as the physical configurations of the control unit 1a, the storage unit 1b, and the communication unit 1c, respectively.

### [2-6. Network Management System]

The network management system 6 is a computer system configured from one or more computers. The network management system 6 provides various functions related to a network, for example, functions of a hub, a router, a firewall, a load balancer, and a DNS server.

The network management system 6 includes a control unit 6a, a storage unit 6b, and a communication unit 6c. The control unit 6a, the storage unit 6b, and the communication unit 6c may have the same physical configurations as the physical configurations of the control unit 1a, the storage unit 1b, and the communication unit 1c, respectively.

### [2-7. Client Terminal]

The plurality of client terminals 7 are each a computer of a client who receives provision of the service from the active system 1. The plurality of client terminals 7 are each a personal computer, a tablet terminal, a smartphone, a wearable terminal, or the like. The number of the client terminals 7 may be one.

The plurality of client terminals 7 each include a control unit 7a, a storage unit 7b, a communication unit 7c, an operating unit 7d, and a display unit 7e. The control unit 7a, the storage unit 7b, and the communication unit 7c may have the same physical configurations as the physical configurations of the control unit 1a, the storage unit 1b, and the communication unit 1c, respectively. The operating unit 7d and the display unit 7e may have the same physical configurations as the physical configurations of the operating unit 4d and the display unit 4e, respectively.

Programs stored in the storage units 1b, 2b, 3b, 4b, 50b, and 51b may be supplied via the network N. Alternatively, programs stored on a computer-readable information storage medium may be supplied via a reading unit for reading an information storage medium (for example, an optical disc drive or a memory card slot), or via an input and output unit (for example, a USB port) through which data is input from and output to an external apparatus.

### [3. Function Configurations of Active System, First Standby System, and Second Standby System]

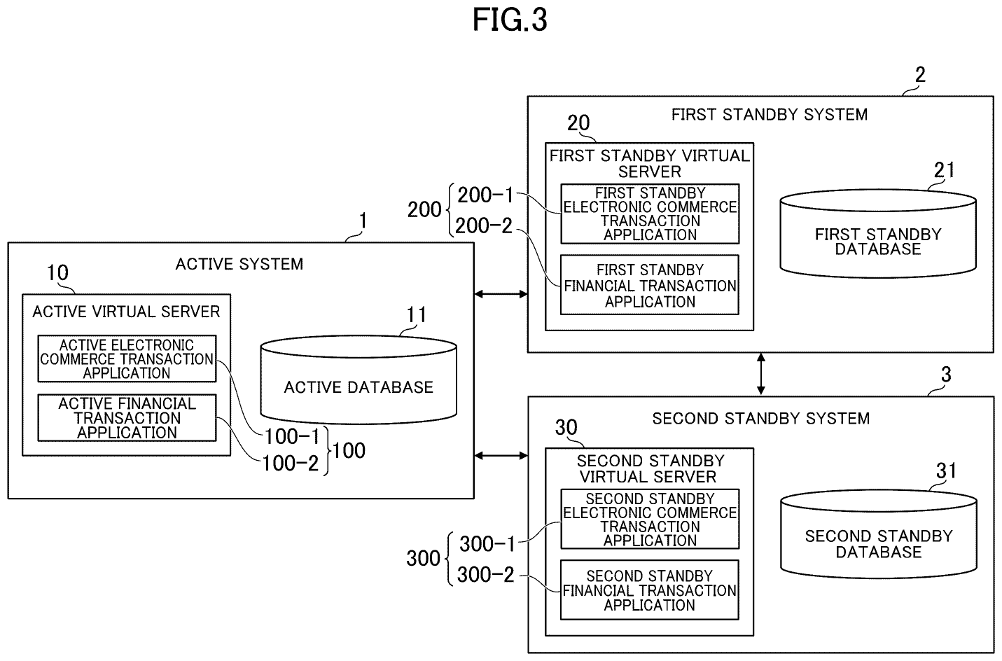

FIG. 3 is a block diagram for illustrating function configurations of the active system 1, the first standby system 2, and the second standby system 3.

### [3-1. Active System]

The active system 1 includes an active virtual server 10 and an active database 11.

The active virtual server 10 is an already activated virtual server on which a plurality of active applications 100 operate. The active virtual server 10 is virtualized by a virtualization technology (not shown) such as hypervisor virtualization or container virtualization which works on the hardware illustrated in FIG. 2.

The plurality of active applications 100 are each an application that provides a function related to the service. In the at least one embodiment, the plurality of active applications 100 include, as an example, an active electronic commerce transaction application active financial 100-1 and an transaction application 100-2. In normal times when the active system 1 is operating normally, the active applications 100 provide the functions related to the service. The number of the active applications 100 may be one.

The active database 11 is a database in which data can be read and written based on instructions from the plurality of active applications 100. Each of the active applications 100 reads data out of and writes data to the active database 11 via a database management system (DBMS) (not shown).

### [3-2. First Standby System]

The first standby system 2 includes a first standby virtual server 20 and a first standby database 21.

The first standby s virtual server 20 is an unactivated virtual server in which a plurality of first standby applications 200 are deployed. As is the active virtual server 10, the first standby virtual server 20 is virtualized by a virtualization technology such as hypervisor virtualization or container virtualization.

The plurality of first standby applications 200 are copies of the plurality of active applications 100. In the at least one embodiment, the first standby applications 200 include, as an example, a first standby electronic commerce transaction application 200-1 and a first standby financial transaction application 200-2. The first standby applications 200 are each installed in a storage unit of the first standby virtual server 20 but, in normal times when the active system 1 is operating normally, do not provide the functions related to the service. The number of the first standby applications 200 may be one.

The first standby database 21 is a database which synchronizes data with the active database 11. Data synchronization between the first standby database 21 and the active database 11 is regularly executed by the database management system (DBMS). In normal times when the active system 1 is operating normally, data can be read out of the first standby database 21 but writing data to the first standby database 21 is inexecutable.

### [3-3. Second Standby System]

The second standby system 3 includes a second standby virtual server 30 and a second standby database 31. The second standby virtual server 30 is an unactivated virtual server in which a plurality of second standby applications 300 are deployed. As is the active virtual server 10, the second standby virtual server 30 is virtualized by a virtualization technology such as hypervisor virtualization or container virtualization.

The plurality of second standby applications 300 are copies of the plurality of active applications 100. In the at least one embodiment, the second standby applications 300 include, as an example, a second standby electronic commerce transaction application 300-1 and a second standby financial transaction application 300-2. The second standby applications 300 are each installed in a storage unit of the second standby virtual server 30 but, in normal times when the active system 1 is operating normally, do not provide the functions related to the service. The number of the second standby applications 300 may be one.

The second standby database 31 is a database which synchronizes data with the active database 11. Data synchronization between the second standby database 31 and the active database 11 is regularly executed by the database management system (DBMS). In normal times when the active system 1 is operating normally, data can be read out of the second standby database 31 but writing data to the second standby database 31 is inexecutable.

### [4. Function Configuration of Switchover Control System]

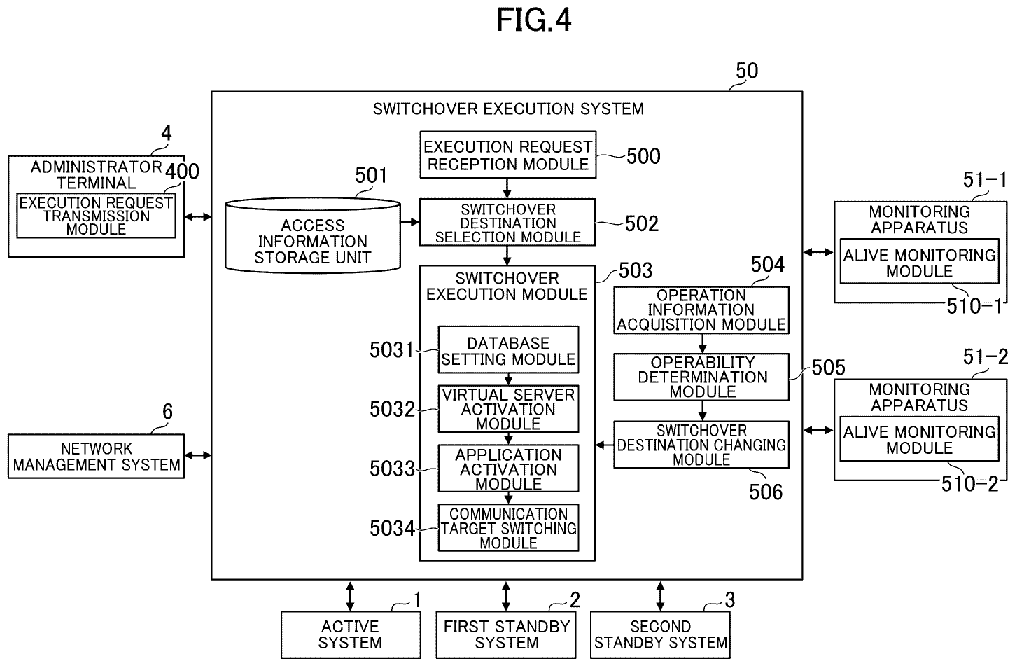

FIG. 4 is a block diagram for illustrating a function configuration of the switchover control system 5 according to the at least one embodiment of the present invention. The switchover control system 5 controls switchover from the active system 1 to one of the first standby system 2 and the second standby system n 3. the following description, the In administrator terminal 4 is also mentioned other than the switchover control system 5 but, in the at least one embodiment, the administrator terminal 4 is not included in the switchover control system 5.

### [4-1. Administrator Terminal]

As illustrated in FIG. 4, the administrator terminal 4 includes, in terms of function, an execution request transmission module 400. The execution request transmission module 400 is implemented mainly by the control unit 4a.

The execution request transmission module 400 transmits a request to execute switchover to the switchover execution system 50. Specifically, the execution request transmission module 400 transmits the switchover execution request to the switchover execution system 50 in response to selection of the “execute” button on the screen G illustrated in FIG. 1C. It goes without saying that the screen related to transmission of the switchover execution request is not limited to the example illustrated in FIG. 1C.

The execution request transmission module 400 may be designed so as to execute authentication on whether a user who attempts to execute transmission of the execution request is one of the administrator and a person authorized by the administrator, or not, and transmit the switchover execution request to the switchover execution system 50 on the condition that the user is successfully authenticated. This configuration can prevent erroneous transmission of the switchover execution request. The authentication itself may be executed by a publicly-known authentication measure.

### [4-2. Switchover Execution System]

As illustrated in FIG. 4, the switchover execution system 50 includes, in terms of function, an execution request reception module 500, an access information storage unit 501, a switchover destination selection module 502, a switchover execution module 503, an operation information acquisition module 504, an operability determination module 505, and a switchover destination changing module 506. The execution request reception module 500, the switchover destination selection module 502, the switchover execution module 503, the operation information acquisition module 504, the operability determination module 505, and the switchover destination changing module 506 are implemented mainly by the control unit 50a. The access information storage unit 501 is implemented mainly by the storage unit 50b.

The execution request reception module 500 receives the switchover execution request transmitted from the administrator terminal 4.

The access information storage unit 501 stores, for each of a plurality of regions, the access information indicating the number of accesses to the active system 1 from the region.

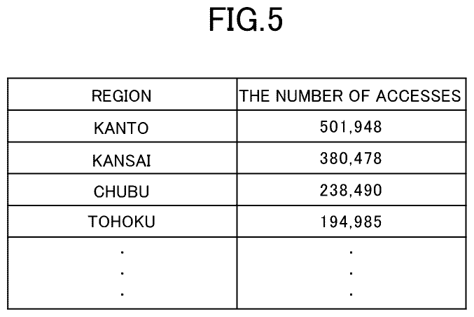

FIG. 5 is a table for showing an example of the access information. As shown in FIG. 5, the access information is data in which each of a plurality of regions is associated with the number of accesses to the active system 1 from the region. The access information may be created for each of the plurality of client terminals 7 that have accessed the active system 1 in a predetermined period by, for example, identifying a location of the client terminal 7 based on an IP address corresponding to the client terminal 7. In FIG. 5, a case in which the regions are region blocks in seven-area classification of Japan including “Kanto” and “Kansai” is shown as an example, but the regions may be prefectures, cities, wards, towns, villages, or the like.

The switchover destination selection module 502 selects one of the first standby system 2 and the second standby system 3 as the switchover destination.

Specifically, the switchover destination selection module 502 selects, as the switchover destination, based on the access information, one of the first standby system 2 and the second standby system 3 that is deployed at a site included in a region higher in the number of accesses to the active system 1. Specifically, the switchover destination selection module 502 refers to contents stored in the access information storage unit 501, and acquires a first number of accesses to the active system 1 from a region including the site at which the first standby system 2 is deployed, and a second number of accesses to the active system 1 from a region including the site at which the second standby system 3 is deployed. The switchover destination selection module 502 compares the first number of accesses and the second number of accesses to obtain the region higher in the number of accesses to the active system 1, and selects the standby system deployed at the site that is included in the obtained region as the switchover destination.

In the at least one embodiment, the switchover destination selection module 502 selects, as the switchover destination, the first standby system 2 deployed in Osaka, which is included in Kansai higher in the number of accesses to the active system 1 as shown in FIG. 5. Accordingly, the following description is premised on that the switchover destination is the first standby system 2. However, the following description applies also to a case in which the switchover destination is the second standby system 3. The “first standby virtual server 20” and the “first standby database 21” in the following description can accordingly be read as the “second standby virtual server 30” and the “second standby database 31.”

The switchover execution module 503 executes the switchover processing. The switchover processing includes the database setting processing, the virtual server activation processing, the application activation processing, and the communication target switching processing. The switchover processing including the database setting processing, the virtual server activation processing, the application activation processing, and the communication target switching processing is executed in response to reception of the execution request, by executing the included processing in the stated order.

The switchover execution module 503 includes a database setting module 5031, a virtual server activation module 5032, an application activation module 5033, and a communication target switching module 5034.

The database setting module 5031 executes the database setting processing for setting the first standby database 21 so that (1) the data synchronization between the active database 11 and the first standby database 21 is stopped and so that (2) writing data based on instructions from the plurality of first standby applications 200 is enabled, and for setting the active database 11 so that (3) writing data based on instructions from the plurality of active applications 100 is disabled. Specifically, the database setting module 5031 transmits a request to execute the database setting processing to the DBMS.

The database setting module 5031 also determines whether the active system 1 is operating normally, based on results of monitoring the active system 1 from the respective sites which are provided by alive monitoring modules 510 of the monitoring system 51 described later, and, when it is determined that the active system 1 is operating normally, does not execute the database setting processing. Specifically, the database setting module 5031 determines that the active system 1 is operating normally when the number of monitoring results concluding that the active system 1 is operating normally is equal to or more than a predetermined number, and does not execute the database setting processing. The database setting module 5031 executes the database setting processing when it is determined that the active system 1 is not operating normally.

The virtual server activation module 5032 executes the virtual server activation processing in which the first standby virtual server 20 is activated. Specifically, the virtual server activation module 5032 transmits a request to execute the virtual server activation processing to the first standby system 2. The first standby system 2 receives the request from the virtual server activation module 5032, and activates the first standby virtual server 20 by allocating computational resources such as a CPU and a memory and executing processing such as setting and activation of an OS with respect to the first standby virtual server 20.

The application activation module 5033 executes the application activation processing in which the plurality of first standby applications 200 are activated on the first standby Specifically, the application activation virtual server 20. module 5033 transmits a request to activate the plurality of first standby applications 200 on the first standby virtual server 20 to the OS of the first standby virtual server 20. The OS of the first standby virtual server 20 receives the request from the application activation module 5033, and activates the plurality of first standby applications 200 on the first standby virtual server 20 by loading the plurality of first standby applications 200 onto a memory of the first standby virtual server 20.

The communication target switching module 5034 executes the communication target switching processing in which the target of communication to and from the plurality of client terminals 7 is switched from the active system 1 to the first standby system 2. Specifically, the communication target switching module 5034 transmits a request to switch the target of communication to and from the plurality of client terminals 7 from the active system 1 to the first standby system 2 to the network management system 6. The network management system 6 receives the request from the communication target switching module 5034, and switches the target of communication to and from the plurality of client terminals 7 from the active system 1 to the first standby system 2 by updating settings of routing of the load balancer included in the network management system 6. The network management system 6 may switch the target of communication to and from the plurality of client terminals 7 from the active system 1 to the first standby system 2 by updating settings of the DNS server included in the network management system 6.

The operation information acquisition module 504 acquires operation information indicating whether the first standby system 2 can operate normally. Specifically, the operation information acquisition module 504 acquires the operation information stored in a storage unit of a management system (not shown) of the cloud system S. The management system may create the operation information by, for example, determining whether the first standby system 2 can operate normally based on a quantity of computational resources available to the first standby virtual server 20. The management system may create the operation information by determining whether the first standby system 2 can operate normally based on a situation of communication between the data center at which the first standby system 2 is deployed and the plurality of client terminals 7. An example of the operation information that may be acquired by the operation information acquisition module 504 is various metrics including golden signals such as a rate of errors in responding to a request, a response time, and a throughput in the standby system that is the subject of the determination.

The operability determination module 505 determines, when the database setting processing is executed and when the application activation processing is executed, whether the first standby system 2 (one of the first standby system 2 and the second standby system 3 that has been selected as the switchover destination by the switchover destination selection module 502) can operate normally, based on the operation information.

The operability determination module 505 may determine whether the standby system selected as the: switchover destination by the switchover destination selection module 502 can operate normally, based on an error rate that is the rate of errors in responding to a request at the data center in which the selected standby system is included. The error rate varies depending on the number of accesses (corresponding to the degree of tightness with regards to access). The operability determination module 505 may also execute the determination based on changes with time (a time evolution) of the error rate. Specifically, when the amount of change of the error rate per unit time at the data center in which the standby system is included is more than or less than a predetermined value, the operability determination module 505 may execute the determination of whether normal operation is possible. The amount of change of the error rate per unit time may be measured for each of one or more standby systems so that the operability determination module 505 determines, based on the amount of change of the error rate, that the standby system relatively large or small in terms of the amount of change can operate normally. Further, the operability determination module 505 may acquire a predicted value of the error rate by performing a time-series analysis based on a statistical model such as a Bayesian structural time-series model, or a machine learning model, and determine that the standby system for which the predicted value is more than or less than a predetermined value can operate normally. The operability determination module 505 may execute the determination based on metrics including the number of accesses, in place of the error rate. There is no limitation on the metrics as long as the operation information acquisition module 504 can acquire the metrics. The operability determination module 505 may present the standby system determined to be capable of operating normally as a candidate when the switchover destination is to be changed by the switchover destination changing module 506 described later. In this case, the switchover destination changing module 506 may change the switchover destination to the standby system determined to be capable of operating normally. The operability determination module 505 in this case executes the determination for each of one or more predetermined standby systems.

In a case in which the first standby system 2 (one of the first standby system 2 and the second standby system 3 that has been selected as the switchover destination by the switchover destination selection module 502) is determined to be incapable of operating normally, the switchover destination changing module 506 changes the switchover destination to the second standby system 3 (another of the first standby system 2 and the second standby system 3), and re-executes the switchover processing from the start.

### [4-3. Monitoring System]

As illustrated in FIG. 4, the monitoring system 51 includes the monitoring apparatus 51-1 and 51-2. The monitoring apparatus 51-1 and 51-2 include, in terms of function, alive monitoring modules 510-1 and 510-2, respectively. The alive monitoring module 510-1 and 510-2 are implemented mainly by the control unit 51a.

The alive monitoring module 510-1 and 510-2 monitor, from their respective sites among a plurality of sites, the active system 1 for whether the active system 1 is operating normally. In the at least one embodiment, the monitoring apparatus 51-1 and 51-2 are installed in South Korea and the United States of America, respectively, and the alive monitoring modules 510-1 and 510-2 accordingly monitor the active system 1 from South Korea and the United States of America, respectively, for whether the active system 1 is operating normally. Specifically, the alive monitoring modules 510-1 and 510-2 each monitor the active system 1 regularly by Ping monitoring using a Ping command, to check whether the active system 1 is operating normally. The alive monitoring modules 510-1 and 510-2 may use various publicly-known monitoring measures other than Ping monitoring, such as SNMP monitoring and port monitoring, to monitor the active system 1 for whether the active system 1 is operating normally. The monitoring apparatus 51-1 and 51-2 transmit results of the monitoring executed by the alive monitoring modules 510-1 and 510-2 to the switchover execution system 50 regularly or in response to a request from the switchover execution system 50.

### [5. Processing of Switchover Control System]

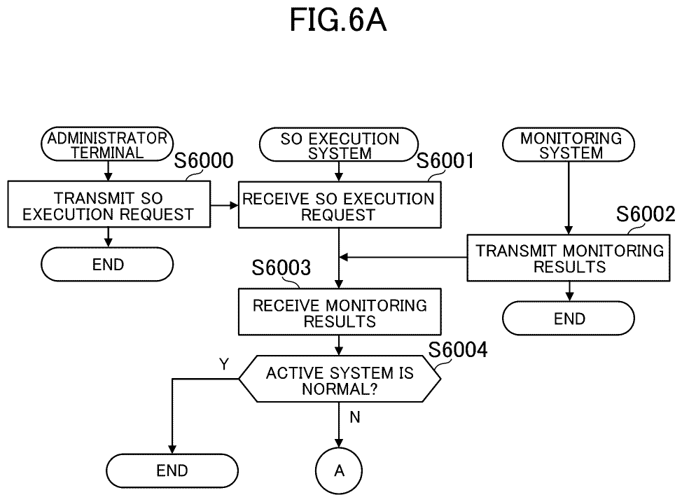

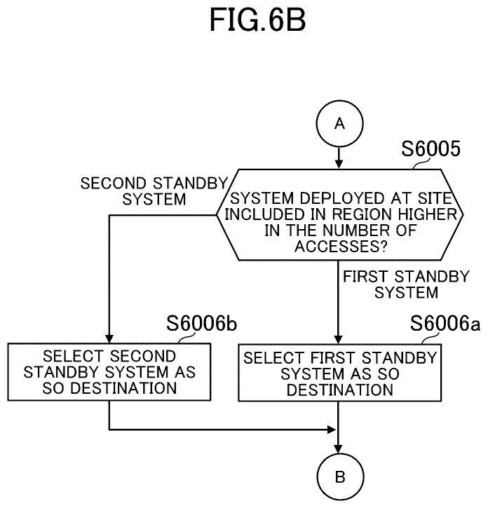

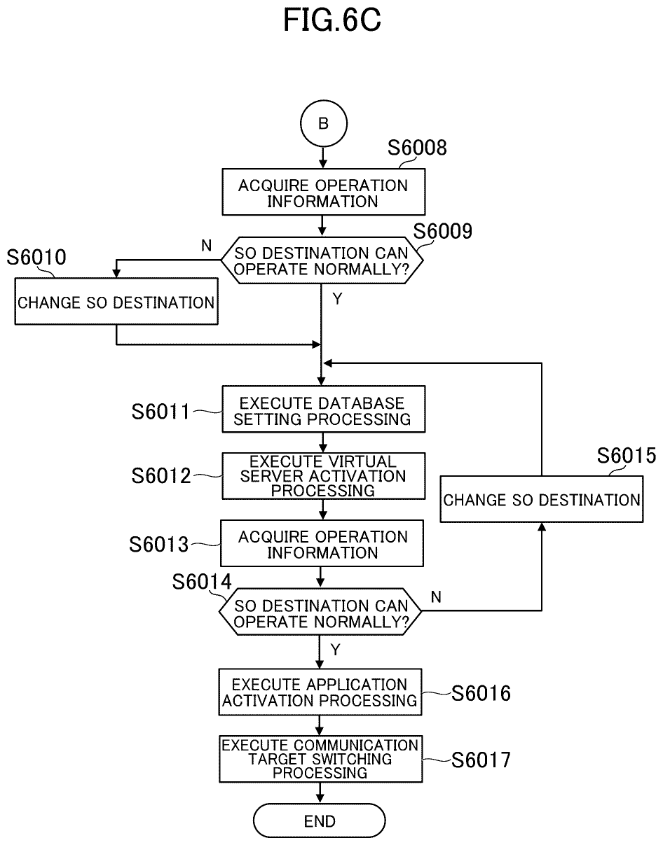

FIG. 6A to FIG. 6C are flow charts for illustrating an example of processing that is executed in the switchover control system according to the at least one embodiment of the present invention. In FIG. 6A to FIG. 6C, “switchover” is abbreviated as “SO” because of limitations of space.

As illustrated in FIG. 6A, the administrator terminal 4 transmits the switchover execution request to the switchover execution system 50 (Step S6000) and ends the processing. The switchover execution system 50 receives the switchover execution request transmitted from the administrator terminal 4 (Step S6001).

Next, the monitoring system 51 transmits, to the switchover execution system 50, results of monitoring the active system 1 for whether the active system 1 is operating normally from each of the plurality of sites (Step S6002), and ends the processing. The switchover execution system 50 receives the monitoring results (Step S6003), and determines whether the active system 1 is operating normally (Step S6004). When it is determined that the active system 1 is operating normally (Step S6004: Y), the switchover execution system 50 ends the processing without executing further steps.

Referring now to FIG. 6B, when it is determined that the active system 1 is not operating normally (Step S6004: N) the switchover execution system 50 refers to the contents stored in the access information storage unit 501, and determines, based on the access information, which of the first standby system 2 and the second standby system 3 is deployed at a site that is included in a region higher in the number of accesses to the active system 1 (Step S6005). When the first standby system 2 is determined to be the standby system deployed at the site that is included in the region higher in the number of accesses to the active system 1, the switchover execution system 50 determines the first standby system 2 as the switchover destination (Step S6006a). When the second standby system 3 is determined to be the standby system deployed at the site that is included in the region higher in the number of accesses to the active system 1, on the other hand, the switchover execution system 50 determines the second standby system 3 as the switchover destination (Step S6006b).

Referring now to FIG. 6C, the switchover execution system 50 acquires the operation information that indicates whether the first standby system 2 can operate normally (Step S6008). The switchover execution system 50 determines whether one of the first standby system 2 and the second standby system 3 that is selected as the switchover destination in Step S6005 can operate normally (Step S6009). When it is determined that the one selected as the switchover destination cannot operate normally (Step S6009: N), the switchover execution system 50 changes the switchover destination (Step S6010), and executes a processing step of Step S6011 described later. When it is determined that the one selected as the switchover destination can operate normally (Step S6009: Y), the process proceeds directly to the processing step of Step S6011 described later.

The switchover execution system 50 executes the database setting processing (Step S6011), and then executes the virtual server activation processing (Step S6012). The switchover execution system 50 acquires the operation information (Step S6013), and determines whether one of the first standby system 2 and the second standby system 3 that is selected as the switchover destination in Step S6005 (in a case in which the switchover destination has been changed in Step S6010, the changed-to switchover destination) can operate normally (Step S6014). When it is determined that the one selected as the switchover destination cannot operate normally (Step S6014: N), the switchover execution system 50 changes the switchover destination (Step S6015), and re-executes Step S6011 and subsequent processing steps. When it is determined that the one selected as the switchover destination can operate normally (Step S6014: Y), the switchover execution system 50 proceeds directly to execution of the application activation processing (Step S6016). Lastly, the switchover execution system 50 executes the communication target switching processing (Step S6017), and ends the processing.

The switchover control system 5 described above enables even a staff member who does not have specialized knowledge about IT infrastructure to execute switchover with ease.

### [6. Modification Examples]

The present invention is not limited to the at least one embodiment described above. The present invention can be modified suitably without departing from the spirit of the present invention.

For example, the sites at which the active system 1, the first standby system 2, the second standby system 3, and the administrator terminal 4 are deployed are not limited to the example given above, and can be any sites.

For example, although the redundancy configuration including three systems that are the active system 1, the first standby system 2, and the second standby system 3 is given as exemplification in the at least one embodiment, a redundancy configuration including two systems that are an active system and a standby system may be employed.

For example, a case in which the administrator terminal 4 and the switchover execution system 50 are configured from different computers is described in the at least one embodiment, but a computer from which the administrator terminal is configured and a computer from which the switchover execution system 50 is configured may be the same.

For example, the switchover execution system 50 may be configured from a plurality of computers. In a case in which the switchover execution system 50 is configured from a plurality of computers, each of the computers may be installed at a different site. That is, a distributed configuration in which a program related to the switchover execution system 50 is divided into a plurality of sub-programs to be executed by computers respectively installed at a plurality of sites may be employed.

For example, the operability determination module 505 may be designed so as to determine whether the first standby system 2 can operate normally in only one of execution of the database setting processing and execution of the application activation processing. The operability determination module 505 may also be designed so as to determine whether the first standby system 2 can operate normally when the application activation processing is executed for some of the first standby applications 200. For example, the operability determination module 505 may determine whether the first standby system 2 can operate normally when the first standby electronic commerce transaction application 200-1 is activated and when the first standby financial transaction application 200-2 is activated.

Although switchover control in a financial transaction service is given as exemplification in the at least one embodiment, the same switchover control can be implemented in various services as well including settlement management, account management, financial product management, electronic commerce transactions, and reward point management. The electronic commerce transactions include commerce transactions related to material objects such as physical goods and commerce transactions related to intangible assets such as reservation of a facility. The financial product includes stocks and bonds handled in stock transactions, insurance products, and the like.

The specific character strings and numerical values described above and the specific character strings in the drawings are merely exemplary, and the present invention is not limited to those character strings and numerical values.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A switchover control system for controlling switchover from an active system to a first standby system in a cloud system in which a network interconnects the active system, the first standby system and an administrator terminal:
the active system deployed at an active site, and comprising:
an already activated active virtual server on which one or more active applications operate; and
an active database configured to read and write data based on instructions from the one or more active applications;
the first standby system deployed at a first standby site different from the active site, and comprising:
an unactivated first standby virtual server in which one or more first standby applications are deployed, the one or more first standby applications being copies of the one or more active applications; and
a first standby database which synchronizes data with the active database; and
the administrator terminal deployed at a management site different from the active site,
the switchover control system being deployed at one or more sites different from the active site,
the switchover control system comprising at least one processor configured to:
receive an execution request for the switchover transmitted from the administrator terminal;
execute database setting processing for setting the first standby database so that data synchronization between the active database and the first standby database is stopped, and so that writing data based on the instructions from the one or more first standby applications is enabled, and for setting the active database so that writing data based on the instructions from the one or more active applications is disabled;
execute virtual server activation processing for activating the first standby virtual server;
execute application activation processing for activating the one or more first standby applications on the first standby virtual server; and
execute communication target switching processing for switching a target of communication to and from one or more client terminals from the active system to the first standby system,
wherein the database setting processing, the virtual server activation processing, the application activation processing, and the communication target switching processing are included in switchover processing, and are executed in the stated order in response to reception of the execution request.

2. The switchover control system according to claim 1, wherein the at least one processor is configured to:
monitor the active system from each of a plurality of sites to check whether the active system is operating normally; and
determine whether the active system is operating normally based on results of monitoring the active system from the plurality of sites, and, when it is determined that the active system is operating normally, cancel execution of the database setting processing.

3. The switchover control system according to claim 1,
wherein the cloud system further includes a second standby system which is deployed at a second standby site different from the active site and from the first standby site, and which comprises:
an unactivated second standby virtual server in which one or more second standby applications are deployed, the one or more second standby applications being copies of the one or more active applications; and
a second standby database which synchronizes data with the active database,
wherein the switchover control system is configured to control switchover from the active system to one of the first standby system and the second standby system, and
wherein the at least one processor is configured to select one of the first standby system and the second standby system as a switchover destination.

4. The switchover control system according to claim 3, further comprising a storage configured to store access information indicating, for each of a plurality of regions, a number of accesses to the active system from the each of the plurality of regions, and
wherein the at least one processor is configured to select, as the switchover destination, based on the access information, one of the first standby system and the second standby system that is deployed at a site included in one of the plurality of regions higher in the number of accesses to the active system.

5. The switchover control system according to claim 3, wherein the at least one processor is configured to:
acquire operation information indicating whether the first standby system is configured to operate normally;
determine, based on the operation information, whether one of the first standby system and the second standby system that is selected as the switchover destination is configured to operate normally, in at least one of the execution of the database setting processing and the execution of the application activation processing executed for at least some of the one or more first standby applications; and
change, when it is determined that the one selected as the switchover destination is configured to operate normally, the switchover destination to another of the first standby system and the second standby system, and re-execute the switchover processing from start.

6. A switchover control method for executing, by a computer deployed at one or more sites different from an active site, control of switchover from an active system to a first standby system in a cloud system in which a network interconnects the active system, the first standby system and an administrator terminal:
the active system deployed at the active site, and comprising:
an already activated active virtual server on which one or more active applications operate; and
an active database configured to read and write databased on instructions from the one or more active applications;
the first standby system deployed at a first standby site different from the active site, and comprising:
an unactivated first standby virtual server in which one or more first standby applications are deployed, the one or more first standby applications being copies of the one or more active applications; and
a first standby database which synchronizes data with the active database; and
the administrator terminal deployed at a management site different from the active site,
the switchover control method comprising:
an execution request reception step of receiving an the switchover transmitted from the execution request for administrator terminal;
a database setting step of setting the first standby database so that between the active database and the first standby database is stopped, and so that writing data based on the instructions from the one or more first standby applications is enabled, and setting the active database so that writing data based on the instructions from the one or more active applications is disabled;
a virtual server activation step of activating the first standby virtual server;
an application activation step of activating the one or more first standby applications on the first standby virtual server; and
a communication target switching step of switching a target of communication to and from one or more client terminals from the active system to the first standby system,
wherein the database setting step, the virtual server activation step, the application activation step, and the communication target switching step are executed in the stated order in response to reception of the execution request.

7. A non-transitory computer readable storage medium having stored thereon a program for causing a computer deployed at one or more sites different from an active site to execute control of switchover from an active system to a first standby system in a cloud system in which a network interconnects the active system, the first standby system and an administrator terminal:
the active system deployed at an active site, and comprising:
an already activated active virtual server on which one or more active applications operate; and
an active database configured to read and write data based on instructions from the one or more active applications;
the first standby system deployed at a first standby site different from the active site, and comprising:
an unactivated first standby virtual server in which one or more first standby applications are deployed, the one or more first standby applications being copies of the one or more active applications; and
a first standby database which synchronizes data with the active database; and
the administrator terminal deployed at a management site different from the active site,
the program causing the computer to:
receive an execution request for the switchover from the administrator terminal;
execute database setting processing for setting the first standby database so that data synchronization between the active database and the first standby database is stopped, and so that writing data based on the instructions from the one or more first standby applications is enabled, and for setting the active database so that writing data based on the instructions from the one or more active applications is disabled;
execute virtual server activation processing for activating the first standby virtual server;
execute application activation processing for activating the one or more first standby applications on the first standby virtual server; and
execute communication target switching processing for switching a target of communication to and from one or more client terminals from the active system to the first standby system,
wherein the database setting processing, the virtual server activation processing, the application activation processing, and the communication target switching processing are executed in the stated order in response to reception of the execution request.
